(19) United States
(12) Patent Application Publication
(10) Pub. No.: US 2019/0319365 A1
(43) Pub. Date: Oct. 17, 2019

(54) ANTENNA AND UNIT-CELL STRUCTURE

(71) Applicant: Samsung Electronics Co., Ltd., Suwon-si (KR)

(72) Inventors: Hyunjin KIM, Suwon-si (KR); Seungtae KO, Suwon-si (KR); Yoongeon KIM, Suwon-si (KR); Youngju LEE, Suwon-si (KR)

(21) Appl. No.: 16/380,512

(22) Filed: Apr. 10, 2019

(30) Foreign Application Priority Data
Apr. 11, 2018 (KR) 10-2018-0042225

(51) Int. Cl. H01Q 21/06; H01Q 9/04; H01Q 19/06

(52) U.S. Cl. CPC H01Q 21/065; H01Q 19/06; H01Q 9/0407

(57) ABSTRACT

An antenna device and a unit-cell structure for an electronic device are provided. The antenna device includes at least one unit-cell that includes a dielectric body having a member with a degree of permittivity, and a perforated unit penetrating upper and lower surfaces of the dielectric body.

### CROSS-REFERENCE TO RELATED APPLICATION(S)

This application is based on and claims priority under 35 U.S.C. 119(a) of a Korean patent application number 10-2018-0042225, filed on Apr. 11, 2018, in the Korean Intellectual Property Office, the disclosure of which is incorporated by reference herein in its entirety.

### BACKGROUND

### 1. Field

The disclosure relates to an antenna and a unit-cell structure. More particularly, the disclosure relates to an electronic device having an antenna including at least one unit-cell.

### 2. Description of the Related Art

Electronic devices can output stored information as sounds or images. In line with the high degree of integration of electronic devices and widespread use of high-speed/large-capacity wireless communication, it has recently become possible to equip a single electronic device, such as a mobile communication device, with various functions. For example, not only a communication function, but also an entertainment function (for example, gaming), a multimedia function (for example, music/moving image playback), communication and security functions for mobile banking and the like, a schedule management function, and an electronic wallet function can be integrated in a single electronic device.

In connection with communication devices mounted in electronic devices, in order to satisfy the wireless data traffic demand that is on the increase since the commercialization of 4^{th} generation (4G) communication systems, there have been ongoing efforts to develop next generation communication systems, for example, next generation (for example, 5^{th} generation (5G)) communication systems or pre-next generation communication systems.

In order to accomplish high data transmission rates, next generation communication systems are being implemented in super-high-frequency bands such as millimeter waves (tens of GHz bands, for example, bands of 6 GHz to 300 GHz). In order to alleviate path loss of radio waves in super-high-frequency bands and to increase the radio wave propagation distance, technologies for beamforming, massive multi-input multi-output (massive MIMO), full dimensional MIMO (FD-MIMO), antenna arrays, analog beamforming, and large-scale antennas are being developed for the next generation communication systems.

The above information is presented as background information only, and to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages, and to provide at least the advantages described below. Accordingly, an aspect of the disclosure is to provide an antenna structure used for next generation communication (for example, millimeter wave communication) that may be influenced by peripheral environments due to high-frequency characteristics.

An aspect of the disclosure is to provide an efficient antenna unit-cell and an efficient antenna unit-cell structure.

In accordance with another aspect of the disclosure, an antenna device is provided. The antenna device includes at least one unit-cell. The at least one unit-cell may include a dielectric body comprising a member having a degree of permittivity, and a perforated unit penetrating upper and lower surfaces of the dielectric body.

In accordance with an aspect of the disclosure, the antenna device may further include a conductor unit positioned on at least one of the upper or lower surfaces of the dielectric body.

In accordance with an aspect of the disclosure, the conductor unit may be made of at least one metal or an alloy of the at least one metal.

In accordance with an aspect of the disclosure, the center point of the dielectric body and the center point of the perforated unit may be identical or substantially identical.

In accordance with an aspect of the disclosure, the perforated unit may be positioned between the outside and inside of the dielectric body.

In accordance with an aspect of the disclosure, the antenna device may further include a connecting unit connecting the outside and inside of the dielectric unit.

In accordance with an aspect of the disclosure, the antenna device may further include an inside perforated unit penetrating upper and lower surfaces of the inside of the dielectric body.

In accordance with an aspect of the disclosure, the perforated unit may include at least one hole having a geometric shape, such as a “ [symbol] ”, “ [symbol] ” or “ [symbol] ” shape.

In accordance with an aspect of the disclosure, the antenna may be a lens antenna.

In accordance with an aspect of the disclosure, the at least one unit-cell may be arranged on one side of the antenna as a closed loop that is symmetric with reference to an identical center point.

In accordance with an aspect of the disclosure, the antenna device may further include an array antenna, and output of the array antenna may be input to a lens antenna including the at least one unit-cell.

In accordance with another aspect of the disclosure, an antenna device is provided. The antenna device includes at least one unit-cell. The at least one unit-cell may include a dielectric body comprising a member having a degree of permittivity, and a conductor unit arranged on at least one of upper or lower surfaces of the dielectric body.

In accordance with an aspect of the disclosure, the antenna device may further include a perforated unit penetrating the upper and lower surfaces of the dielectric body.

In accordance with an aspect of the disclosure, the perforated unit may be positioned between the outside of the dielectric body and the inside of the dielectric body, and the at least one unit-cell may further include a connecting unit connecting the outside of the dielectric unit and inside of the dielectric unit.

In accordance with an aspect of the disclosure, the antenna device may further include an inside perforated unit penetrating upper and lower surfaces of the inside of the dielectric body.

In accordance with an aspect of the disclosure, the perforated unit may include at least one hole having a geometric shape, such as a “ [symbol] ”, “ [symbol] ” or “ [symbol] ” shape.

In accordance with another aspect of the disclosure, a unit-cell is provided on a lens antenna. The unit-cell includes a dielectric body comprising a member having a degree of permittivity, and a perforated unit penetrating upper and lower surfaces of the dielectric body.

In accordance with an aspect of the disclosure, the unit-cell may further include a conductor unit positioned on at least one of the upper or lower surfaces of the dielectric body.

In accordance with another aspect of the disclosure, a unit-cell is provided on a lens antenna. The unit-cell includes a dielectric body comprising a member having a degree of permittivity, and a conductor unit positioned on at least one of upper or lower surfaces of the dielectric body.

In accordance with an aspect of the disclosure, the unit-cell may further include a perforated unit penetrating the upper and lower surfaces of the dielectric body.

According to embodiments of the disclosure, it is possible to reduce the phase error of an antenna.

According to embodiments of the disclosure, it is also possible to increase the antenna gain of an antenna.

According to embodiments of the disclosure, it is further possible to reduce the dielectric loss of an antenna.

According to embodiments of the disclosure, it is still further possible to reduce the sensitivity of an antenna to external environments such as wind and rain.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication environment including an electronic device and a base station according to an embodiment of the disclosure;

FIG. 2 illustrates a communication antenna provided in an electronic device according to an embodiment of the disclosure;

FIG. 3 illustrates a lens antenna according to an embodiment of the disclosure;

FIG. 4 illustrates an antenna unit-cell according to an embodiment of the disclosure;

FIG. 5 illustrates another antenna unit-cell according to an embodiment of the disclosure;

FIG. 6A is a perspective view of an antenna unit-cell according to an embodiment of the disclosure;

FIG. 6B is a perspective view of another antenna unit-cell according to an embodiment of the disclosure;

FIG. 7 illustrates a relationship between a size of a conductor unit and a phase available to a unit-cell according to an embodiment of the disclosure;

FIG. 8A is a top view of an antenna unit-cell according to various embodiments;

FIG. 8B is a top view of an antenna unit-cell according to various embodiments;

FIG. 8C is a top view of an antenna unit-cell according to various embodiments;

FIG. 8D is a top view of an antenna unit-cell according to various embodiments;

FIG. 9A is a perspective view of an antenna unit-cell according to various embodiments;

FIG. 9B is a perspective view of an antenna unit-cell according to various embodiments;

FIG. 9C is a perspective view of an antenna unit-cell according to various embodiments;

FIG. 10A is a sectional view of an antenna unit-cell according to various embodiments;

FIG. 10B is a sectional view of an antenna unit-cell according to various embodiments;

FIG. 10C is a sectional view of an antenna unit-cell according to various embodiments;

FIG. 10D is a sectional view of an antenna unit-cell according to various embodiments;

FIG. 10E is a sectional view of an antenna unit-cell according to various embodiments;

FIG. 10F is a sectional view of an antenna unit-cell according to various embodiments;

FIG. 11A illustrates a type of arrangement of at least one unit-cell on a lens antenna according to an embodiment of the disclosure;

FIG. 11B illustrates an exemplary type of arrangement of at least one unit-cell on a lens antenna according to one of various embodiments;

FIG. 11C illustrates an exemplary type of arrangement of at least one unit-cell on a lens antenna according to one of various embodiments;

FIG. 12A illustrates another type of arrangement of at least one unit-cell on a lens antenna according to an embodiment of the disclosure;

FIG. 12B illustrates an enlargement of a type of arrangement of at least one unit-cell on a lens antenna according to an embodiment of the disclosure;

FIG. 13 illustrates a result of a signal passing through a lens antenna according to an embodiment of the disclosure;

FIG. 14 illustrates a result of another signal passing through a lens antenna according to an embodiment of the disclosure; and

FIG. 15 illustrates hole shapes (a) to (f) provided in perforated units according to embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of embodiments of the disclosure as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used to enable a clear and consistent understanding of the disclosure. Accordingly, it should be apparent to those skilled in the art that the following description of embodiments of the disclosure is provided for illustration purpose only, and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. In addition, it is to be understood that “at least one of a, b or c” is “only a, only b, only c, both a and b, both a and c, both b and c, all of a, b, and c, or variations thereof.”

Prior to detailed descriptions of the disclosure, terms such as “first” and “second” may be used throughout the specification to describe various constituent elements, but the constituent elements are not to be limited by the terms. The terms are used only to distinguish a constituent element from another constituent element. A singular expression also includes a plural expression unless explicitly indicated otherwise in the context. In addition, the description that a part “includes” a constituent element does not exclude other constituent elements, but means that the part may include other constituent elements unless specifically indicated otherwise.

Functions provided within constituent elements and “units” may be combined into a smaller number of constituent elements and “units”, or further separated into additional constituent elements and “units”.

Although specific embodiments will be described in the detailed description of the disclosure, it should be understood that various modifications are possible without departing from the scope of the disclosure. Accordingly, the scope of the disclosure is not to be defined as being limited to the described embodiments, but is to be defined not only by the accompanying claims but also by equivalents thereof.

Embodiments of the disclosure is to provide an antenna unit-cell that is efficient in terms of costs and design.

Embodiments of the disclosure is to provide an antenna unit-cell structure that can widen the range of phase available to the antenna.

Embodiments of the disclosure is to provide an antenna unit-cell structure which has reduced sensitivity to influences of external environments (for example, wind and rain).

Embodiments of the disclosure propose a method for improving the performance of an antenna.

Embodiments of the disclosure also propose a method for improving the radiation performance and/or antenna gain of a planar lens antenna.

Embodiments of the disclosure further propose an antenna including at least one unit-cell including a dielectric body, a hole, and a conductor unit in order to improve the radiation performance and/or antenna gain.

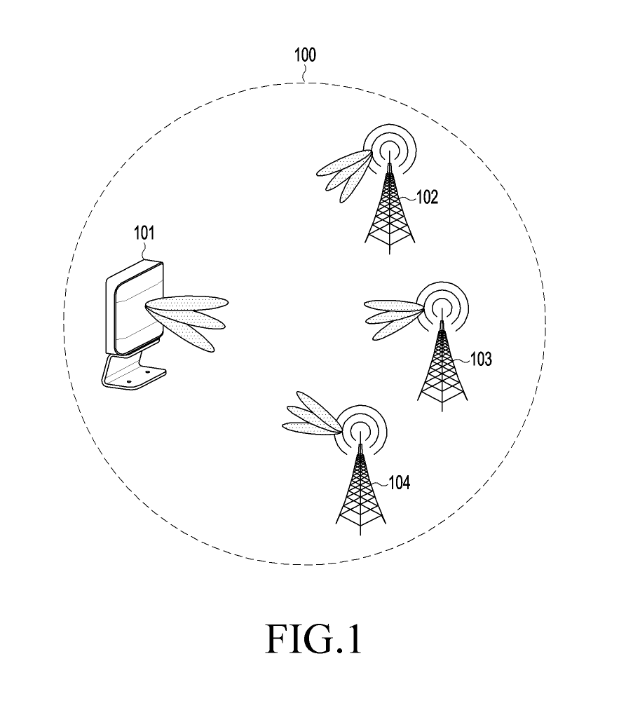

FIG. 1 illustrates a wireless communication environment including an electronic device and a base station according to an embodiment of the disclosure.

Referring to FIG. 1, a wireless communication environment 100 to which embodiments of the disclosure may be applied may include an electronic device 101 and at least one base station 102, 103, and 104. The electronic device 101 may perform communication with the at least one base station 102, 103, and 104. Although it is assumed in FIG. 1 for convenience of description that the wireless communication environment 100 includes only three base stations 102, 103, and 104, the number of base stations that the wireless communication environment 100 includes or the number of base stations that can communicate with the electronic device 101 is not limited thereto. The wireless communication environment 100 may further include other network entities that can communicate with the electronic device 101 besides the base stations.

The electronic device 101 in FIG. 1 may be, for example, customer-premises equipment (CPE) or customer-provided equipment (CPE), which refers to all terminals and related equipment that are installed in a subscriber's house (indoor) and connected to an end point of a communication provider. For example, the CPE may refer to a product that connects to a service provided by a communication service provider and makes it possible to use the service inside the house through a local access network (LAN), including a telephone, a router, a switch, a residential gateway (RG), a set-top box, a fixed mobile convergence product, a home networking adapter, and an Internet access gateway. As another example, the electronic device 101 may be a user equipment (UE), a terminal device, a base station, or another network entity.

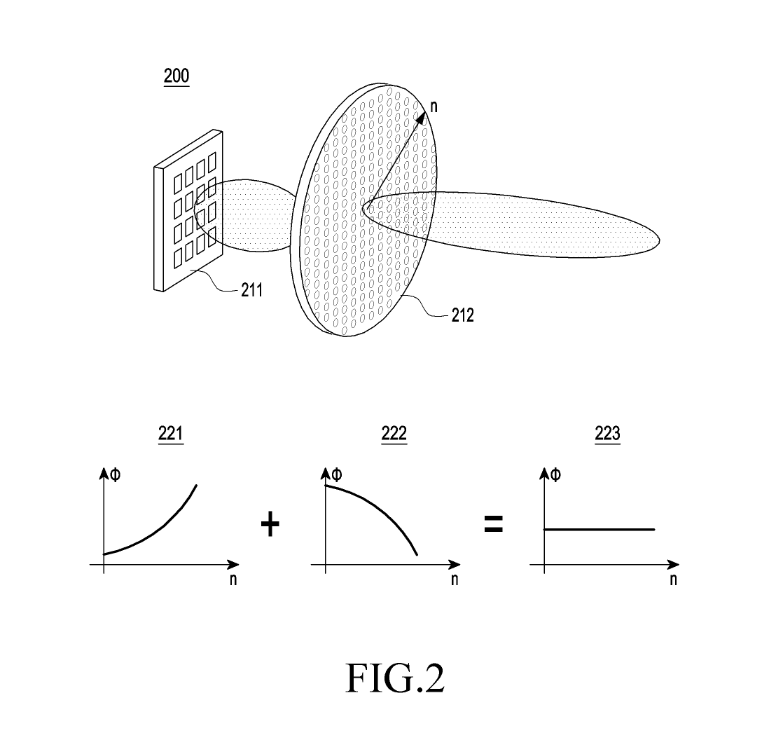

FIG. 2 illustrates a communication antenna provided in an electronic device according to an embodiment of the disclosure.

Referring to FIG. 2, a communication antenna 200 includes an array antenna 211 and a lens antenna 212. The communication antenna 200 may be provided, for example, in the electronic device 101 described above with reference to FIG. 1.

The array antenna 211 is a device configured to transmit and receive radio waves, and may include a linear array antenna, a planar array antenna, a nonplanar array antenna, a fixed array antenna, a phased array antenna, and the like. The array antenna 211 may include a system that automatically optimizes the beam pattern of the antenna according to a predetermined algorithm by using information obtained by receiving an input signal through each antenna element of an antenna array having a special structure. Such an array antenna system may provide an ideal beam that gives a desired terminal the maximum gain and gives the minimum gain in an undesired direction by using a parameter value calculated from a received signal. However, in order to provide ideal beam characteristics, the phase profile of an RF path between each array antenna and the antenna element needs to be corrected identically, and a calibration technology may be used as a technology for correction. As used herein, the calibration technology may refer to an operation of adjusting the (antenna) characteristics such that the same conform to a predetermined standard.

The phase of a signal (wave) transmitted from the array antenna 211 may tend to increase in proportion to the distance from the center of the array antenna (or the center of a lens antenna arranged to correspond to the array antenna). Accordingly, when the array antenna 211 is solely used, a phase difference may occur with reference to the signal to be transmitted originally, or the antenna gain may decrease. As used herein, the antenna gain may refer to an increase of power density in the area in which radio waves are actually received, as a result of gathering and sending radio wave beams in the desired direction. As used herein, the phase may refer to the degree of delay of a sine wave or a cosine wave.

The lens antenna 212 may be an antenna which concentrates the planar wave front of an electromagnetic wave at a focal point, or which conversely radiates a spherical wave diverging from a point source as a plane wave.

FIG. 2 illustrates a case in which the communication antenna 200 includes an array antenna 211 and a lens antenna 212. The phase of a signal (wave) transmitted from the lens antenna 212 or the degree of delay of the phase may tend to decrease in proportion to the distance from the center of the lens antenna 212. Accordingly, for example, when a signal is transmitted (sent) by using a communication antenna 200 having an array antenna 211 and a lens antenna 212 arranged consecutively as illustrated in FIG. 2 (or the lens antenna 212 being installed in front of the array antenna 211), it is possible to transmit a signal having the same phase even if the distance from the antenna center changes. This may convert the phase profile of an electromagnetic wave in a space into the same phase such that the antenna gain is advantageously increased. That is, a signal that propagates straightly can be released by using a communication antenna 200 including an array antenna 211 and a lens antenna 212.

Referring to FIG. 2, the first graph 221 illustrates a case wherein the phase “ϕ” of a signal sent from the array antenna 211 tends to increase in proportion to the distance (“n” in FIG. 2) from the center of the lens antenna 212 with reference to the position of the lens antenna 212. For example, the first graph 221 may illustrate a case wherein, assuming that there is no lens antenna 212, in the position in which the lens antenna 212 is to be arranged, the phase of a signal sent from the array antenna 211 increases in proportion to the distance from the center of the lens antenna 212. As another example, the first graph 221 may illustrate the result of measuring a signal sent from the array antenna 211 immediately before the same reaches the lens antenna 212.

The second graph 222 illustrates a case wherein the phase of a signal which is incident into the lens antenna 212, and which then passes through or penetrates the lens antenna 212, tends to decrease (or the degree of delay of the phase tends to decrease) in proportion to the distance (“n” in FIG. 2) from the center of the lens antenna 212. For example, the second graph 222 may illustrate characteristics of the lens antenna 212, and may change depending on the type of the lens antenna 212.

The third graph 223 illustrates a signal tendency that can be obtained when a signal sent from the array antenna 211 passes through or penetrates the lens antenna 212. For example, the third graph 223 may illustrate a case wherein an equiphase signal is sent by using a communication antenna 200 including the array antenna 211 and the lens antenna 212. The third graph 223 also illustrates a case wherein an antenna gain can be obtained by using the communication antenna 200 including the array antenna 211 and the lens antenna 212. As used herein, the antenna gain may refer to an increase of power density in the area in which radio waves are actually received, as a result of gathering and sending radio wave beams in the desired direction. The lens antenna 212 may play the role of compensating for the phase of the signal sent from the array antenna 211. That is, the communication antenna 200 including the array antenna 211 and the lens antenna 212 can transmit a signal having the same phase (ϕ) regardless of any difference in the distance from the center of the lens antenna 212.

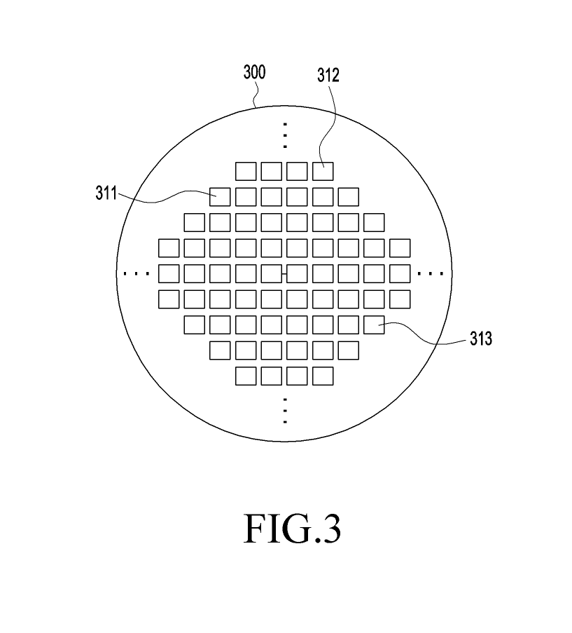

FIG. 3 illustrates a lens antenna according to an embodiment of the disclosure.

Referring to FIG. 3, a lens antenna 300 may include at least one unit-cell 311, 312, 313, . . . and so forth. For example, the at least one unit cell 311, 312, 313, . . . and the substrate of the lens antenna 300 may be coupled to each other by chemical and/or physical coupling. The lens antenna 300 of FIG. 3 may be provided in the electronic device 101 of FIG. 1, for example, and may be the lens antenna 212 of FIG. 2.

For example, the range of phase that the unit cells 311, 312, 313 . . . can cover is as follows. In the case of a unit-cell having a single-layer structure, a range of about 50° can be covered. In the case of a unit-cell having a two-layer structure, a range of about 170° can be covered. In the case of a unit-cell having a three-layer structure, a range of about 300° can be covered. In the case of a unit-cell having a five-layer structure, a range of about 360° can be covered. The number of layers constituting a unit-cell may be determined on the basis of the number of flat plates (or substrates) constituting the unit cell 311, 312, 313, . . . and so forth.

In order to guarantee that there is comparatively no performance degradation in terms of antenna design, the range of phase that an antenna can use (cover) needs to be about 300°. That is, there is a need for a unit-cell having a three-layer structure, which can cover a phase range of about 300°. However, considering, in terms of costs, the fact that the lower the number of layers constituting a unit-cell, the lower the required cost, the disclosure proposes a technology for widening the range of phase that a unit-cell having a single-layer or two-layer structure (or a lens antenna including multiple unit-cells) can cover.

That is, the disclosure hereinafter proposes various unit-cell structures.

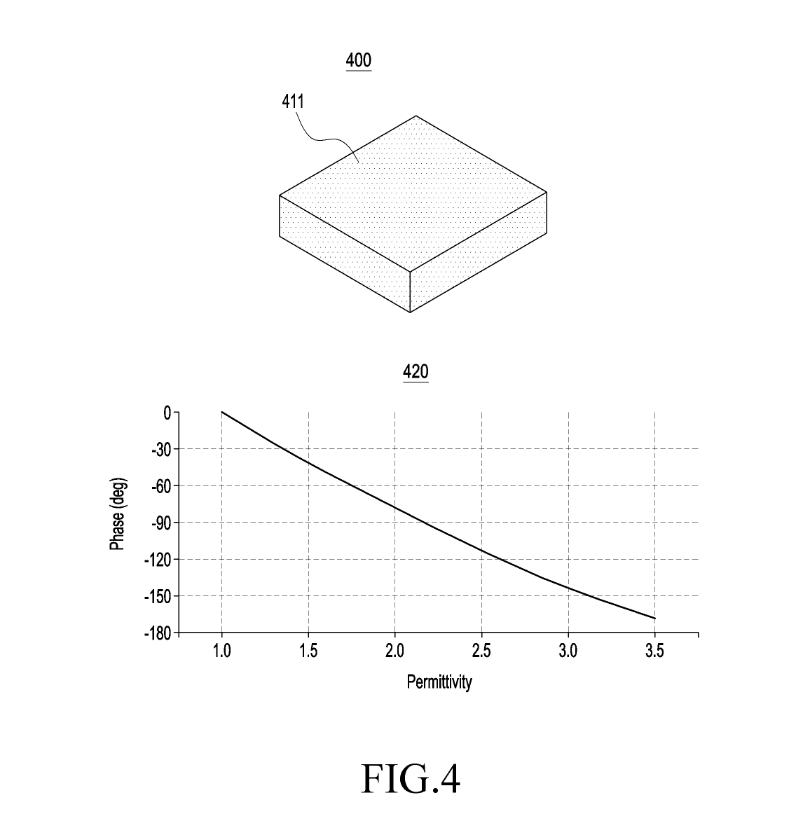

FIG. 4 illustrates an antenna unit-cell according to an embodiment of the disclosure.

Referring to FIG. 4, an antenna unit-cell 400 may be a cell configured as a dielectric body 411 according to an embodiment. The dielectric body 411 may comprise a material that reacts with an external electric field and generates an electric dipole, such as a material (for example, flame-retardant 4 (FR-4), Teflon, polytetrafluoroethylene (PTFE)) that can be used for a printed circuit board (PCB), printable synthetic resin (polycarbonate, polyethylene (PE), polyethylene terephthalate (PET), or the like), or ceramic (low temperature co-fired ceramic (LTCC)). The type of the material constituting the dielectric body 411 is not limited to the above description.

A graph 420 of FIG. 4 illustrates a relationship between the permittivity of the unit-cell 400 including the dielectric body 411 and the phase (degree) (or “phase available to the unit-cell”) of the signal when an incident wave has passed through or penetrated the unit-cell 400 including the dielectric body 411. It can be understood from the graph 420 of FIG. 4 that, the higher the permittivity of the dielectric body 411, the larger the phase available to the unit-cell 400. That is, the permittivity of the dielectric body 411 and the magnitude of the absolute value of the phase available to the unit-cell 400 are proportional to each other.

Referring to the graph 420 of FIG. 4, when the permittivity of the dielectric body 411 is 1.0, the phase when the incident wave has penetrated (passed through) the unit-cell 400 may correspond to about 0°, and, when the permittivity of the dielectric body 411 is 3.5, the phase when the incident wave has penetrated the unit-cell 400 may correspond to about (−) 170°. The values given in the graph 420 of FIG. 4 are merely for the purpose of illustrating test results, and the phase corresponding to the permittivity of the dielectric body 411 may differ from that given in the graph 420 of FIG. 4.

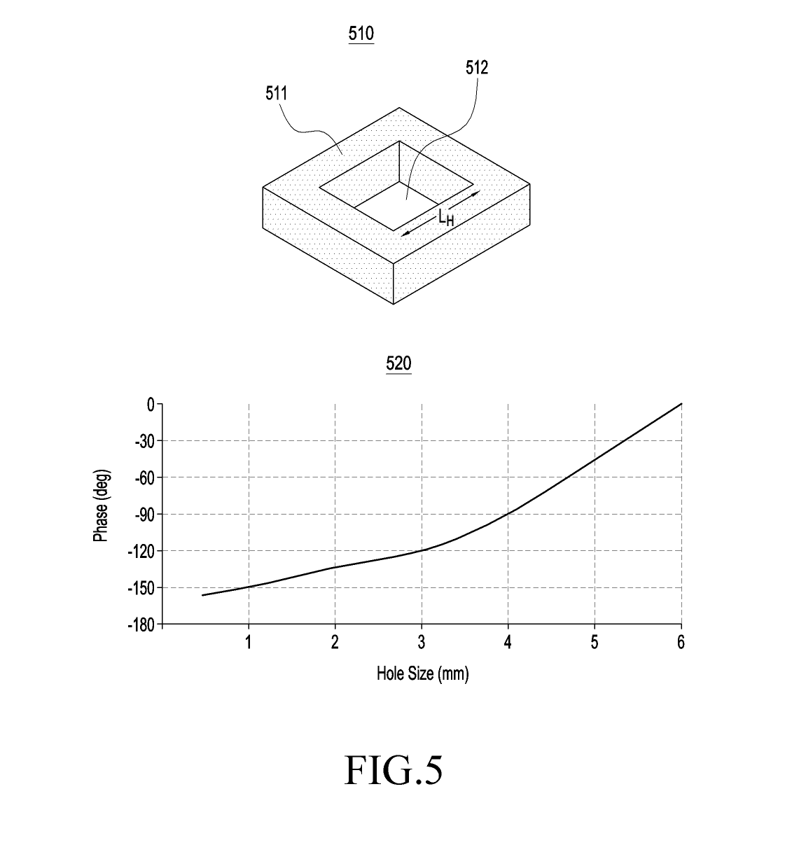

FIG. 5 illustrates another antenna unit-cell according to an embodiment of the disclosure.

Referring to FIG. 5, an antenna unit-cell 510 may be a cell including a dielectric body 511 including a perforated unit 512 according to an embodiment. The perforated unit 512 may also be referred to as an opening that penetrates the upper and lower surfaces of the unit-cell 510, a hole, a through-hole, a cavity, an empty space, or air.

The exterior of the dielectric body 511 may be formed in a square or rectangular shape, for example, when viewed from above as illustrated in FIG. 5. In addition, the exterior of the dielectric body 511 may be formed in a square or rectangular shape in the following manner A hexahedron-shaped perforated unit 512 is formed at the center of a dielectric body formed in a hexahedron shape such that, when the dielectric body 511 is viewed from above, a square or rectangular perforated unit 512 is positioned at the center of the upper surface of the dielectric body 511, and the dielectric body 511 surrounds the perforated unit 512.

The perforated unit 512 may have an upper surface formed in a quadrangular shape, for example, as illustrated in FIG. 5. As another example, the perforated unit 512 may have an upper surface formed in another shape, such as a polygon, a circle, or a ring.

The perforated unit 512 may have a shape, for example, corresponding to or equal to that of the unit-cell 510 or the dielectric body 511. For example, the perforated unit 512 may include a square or rectangular hole formed in the square or rectangular unit-cell 510 or dielectric body 511. Alternatively, the perforated unit 512 may be formed along the edge of the square or rectangular unit-cell 510 or dielectric body 511, not at the center thereof, such that the perforated unit 512 surrounds the dielectric body positioned at the center of the unit-cell 510. As another example, the shape of the perforated unit 512 may not correspond to or may differ from the shape of the unit-cell 510 or the dielectric body 511.

The perforated unit 512 may be formed, for example, such that the center of the perforated unit 512 is identical to the center of the unit-cell 510 or the dielectric body 511. As another example, the perforated unit 512 may be formed in a position other than the center of the unit-cell 510 or the dielectric body 511. For example, the perforated unit 512 may include at least two holes such that the center of the at least two holes may deviate from the center of the unit-cell 510 or the dielectric body 511.

The perforated unit 512 may have a dimension L_{H} corresponding to the size of the unit-cell 510. For example, the perforated unit 512 may have a dimension L_{H} smaller than the size of the unit-cell 510, that is, the size of the dielectric body 511.

The unit-cell 510 may include a single perforated unit 512 as illustrated in FIG. 5. As another example, the unit-cell 510 may include two or more perforated units, and the shape of the two or more perforated units, the size thereof, and/or the interval between the two or more perforated units may be uniform (identical) to each other or different from each other.

As the unit-cell 510 further includes a perforated unit 512 as described above, the sensitivity of the antenna including the unit-cell 510 to the influences of external environments (such as wind and rain) can be reduced. That is, it is possible to reduce the performance deviation of the antenna (or electric device) resulting from external environments, or to make a design that reduces external influences. In addition, mechanically unstable aspects can be removed when the antenna (or electronic device) includes a unit-cell 510 including a perforated unit 512.

Moreover, the dielectric body 511 itself has a dielectric loss, and, when the antenna unit-cell 510 includes a perforated unit 512, the space occupied by the dielectric body 512 is replaced with air, thereby reducing the dielectric loss. As used herein, the dielectric loss may refer to a power loss or the like occurring when a signal passes through the dielectric body.

A graph 520 of FIG. 5 illustrates a relationship between the dimension L_{H} of the perforated unit 512 (Hole Size) and the phase (degree) (also referred to as the “phase available to the unit-cell”) of the signal when an incident wave has passed through or penetrated the unit-cell 500 including the dielectric body 511 and the perforated unit 512. It can be understood from the graph 520 of FIG. 5 that, the larger the size of the perforated unit 512, the smaller the phase available to the unit-cell 510 or the degree of delay of the phase becomes.

It can also be understood with reference to the graph of FIG. 5 that a phase range of about 160° is available according to the size of the perforated unit 512. The values given in the graph 520 of FIG. 5 are merely for the purpose of illustrating test results according to an example, and the phase corresponding to the size of the perforated unit 512 may differ from that given in the graph 520 of FIG. 5.

It could also be understood with reference to the graph 420 of FIG. 4 and graph 520 of FIG. 5 that, by adjusting the size of the perforated unit 512, the range of phase available to the unit-cell 510 can be adjusted as in the case of changing the permittivity of the dielectric body 411. For example, when the lens antenna includes multiple unit-cells 510 having difference sizes of perforated units 512, it becomes possible to produce a lens antenna capable of adjusting the phase of a signal penetrating the lens antenna by using the same dielectric body having the same permittivity. Accordingly, the fact that a single dielectric body can be used to manufacture an antenna may be efficient in terms of process simplification.

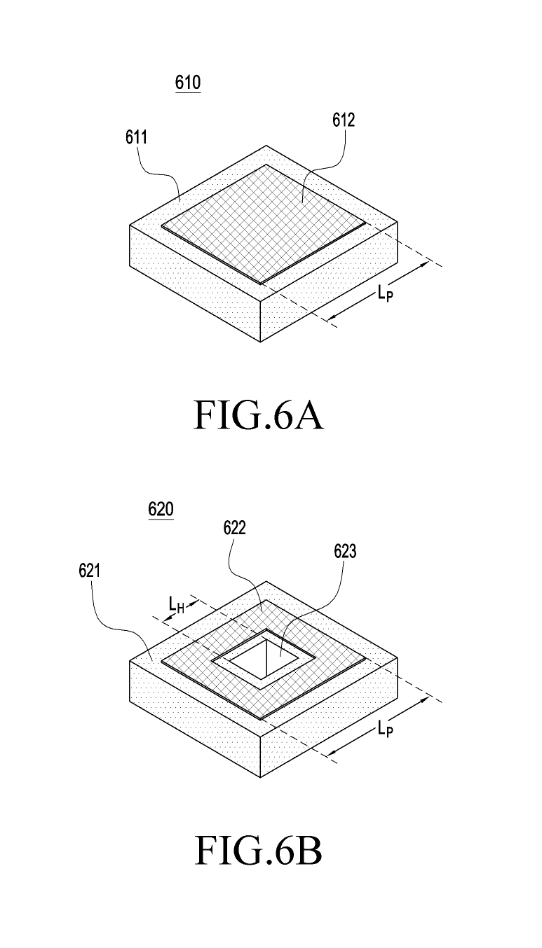

FIG. 6A is a perspective view of an antenna unit-cell according to an embodiment of the disclosure. FIG. 6B is a perspective view of another antenna unit-cell according to an embodiment of the disclosure.

FIG. 6A illustrates a unit-cell 610 including a dielectric body 611 and a conductor unit 612 according to an embodiment. FIG. 6B includes a unit-cell 620 including a dielectric body 621, a conductor unit 622, and a perforated unit 623 according to another embodiment.

Referring to FIG. 6A, the unit-cell 610 according to an embodiment may include the dielectric body 611 and conductor unit 612. The conductor unit 612 may also be referred to as a conductor pattern, a metal pattern, a pattern unit, a patterning unit, or the like. For example, the conductor unit 612 may be a member made of copper (Cu), silver (Ag), gold (Au), iron (Fe), platinum (Pt), tungsten (W), or an alloy thereof. The type of the material constituting the conductor unit 612 is not limited to the above description.

The conductor unit 612 may be formed on or attached to the upper surface of the dielectric body 611 and/or the lower surface thereof. For example, the conductor unit 612 may be a member seated (loaded) on the upper surface of the dielectric body 611 and/or the lower surface thereof. As another example, the conductor unit 612 may be coupled to the upper surface of the dielectric body 611 and/or the lower surface thereof by physical or chemical coupling.

Referring to FIG. 6B, the unit-cell 620 according to another embodiment includes the dielectric body 621, the conductor unit 622, and the perforated unit 623. The above descriptions of the unit-cell 610, the dielectric body 611, and the conductor unit 612 according to an embodiment are also applicable to the unit-cell 620, the dielectric body 621, and the conductor unit 622 according to another embodiment.

The perforated unit 623 may have an upper surface formed in a quadrangular shape, for example, as illustrated in FIG. 6B. As another example, the perforated unit 623 may have an upper surface formed in another shape, such as a polygon, a circle, or a ring.

The perforated unit 623 may have a shape, for example, corresponding to or equal to that of the unit-cell 620 or the dielectric body 621. For example, the perforated unit 623 may include a square or rectangular hole formed in the square or rectangular unit-cell 620 or dielectric body 621. Alternatively, the perforated unit 623 may be formed along the edge of the square or rectangular unit-cell 620 or dielectric body 621, not at the center thereof, such that the perforated unit 623 surrounds the dielectric body positioned at the center of the unit-cell 620. As another example, the shape of the perforated unit 623 may not correspond to or may differ from the shape of the unit-cell 620 or the dielectric body 621.

The perforated unit 623 may be formed, for example, such that the center of the perforated unit 623 is identical to the center of the unit-cell 620 or the dielectric body 621. As another example, the perforated unit 623 may be formed in a position other than the center of the unit-cell 620 or the dielectric body 621. For example, the perforated unit 623 may include at least two holes such that the center of the at least two holes may deviate from the center of the unit-cell 620 or the dielectric body 621.

The perforated unit 623 may have a dimension L_{H} corresponding to a dimension L_{P} of the conductor unit 622 or the size of the unit-cell 620. For example, the perforated unit 623 may have a dimension L_{H} smaller than the size of the unit-cell 620, that is, the size of the dielectric body 621.

The unit-cell 620 may include a single perforated unit 623 as illustrated in FIG. 6B. As another example, the unit-cell 620 may include two or more perforated units, and the shape of the two or more perforated units, the size thereof, and/or the interval between the two or more perforated units may be uniform (identical) to each other or different from each other.

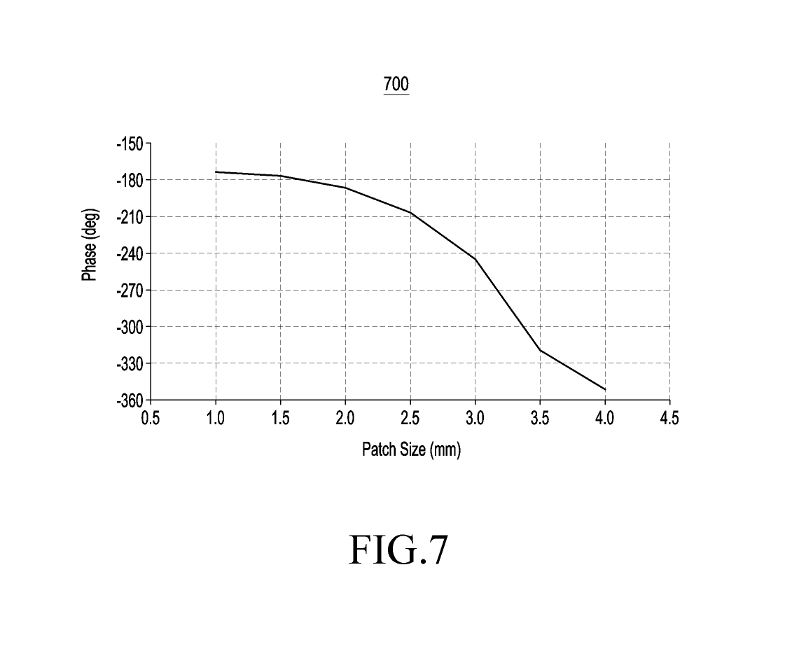

FIG. 7 illustrates a relationship between a size of a conductor unit and a phase available to a unit-cell according to an embodiment of the disclosure.

Referring to FIG. 7, the graph 700 of FIG. 7 illustrates a case wherein a degree of delay of the phase of a signal penetrating the unit-cell increases in proportion to the patch dimension L_{P} of the conductor unit.

The graph 700 of FIG. 7 illustrates, for example, the result of measurement when the dimension L_{H} of the perforated unit of the unit-cell remains 0.5 mm, and the dimension L_{P} of the conductor unit that the unit-cell includes is varied. It can be confirmed with reference to the graph 700 of FIG. 7 that, as the size of the perforated portion of the unit-cell varies from 1 mm to 4 mm, the range of phase available to the unit-cell increase from (−) 170° to (−)350°.

Referring to the graph 520 of FIG. 5 and the graph 700 of FIG. 7, as the lens antenna includes a combination of at least one unit-cell including at least one of a dielectric body, a perforated unit, or a conductor unit, the lens antenna becomes able to generate a phase difference of 0° to (−)360°. That is, the lens antenna becomes able to secure the entire phase range of 360°.

In addition, a lens antenna including at least one unit-cell according to the disclosure can secure a phase range of 360°, which is necessary in terms of antenna design, while using unit cells having a single-layer structure, which are efficient in terms of production costs.

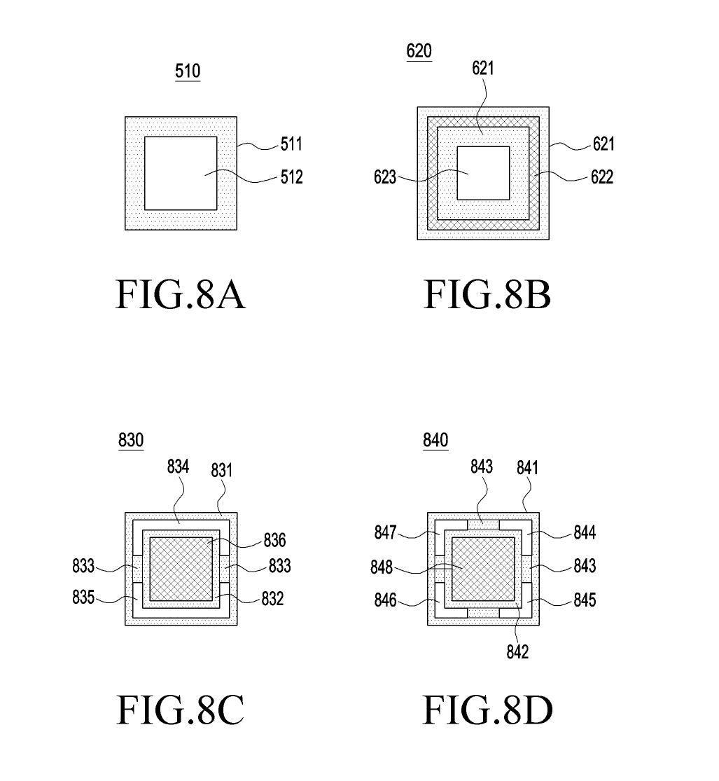

FIG. 8A is a top view of an antenna unit-cell according to various embodiments of the disclosure. FIG. 8B is a top view of an antenna unit-cell according to various embodiments of the disclosure. FIG. 8C is a top view of an antenna unit-cell according to various embodiments of the disclosure. FIG. 8D is a top view of an antenna unit-cell according to various embodiments of the disclosure.

FIG. 8A is a top view of the unit-cell 510 of FIG. 5 according to an embodiment of the disclosure.

Referring to FIG. 8A, the unit-cell 510 according to an embodiment may be a cell including the dielectric body 511 and the perforated unit 512.

FIG. 8B is a top view of the unit-cell 620 of FIG. 6 according to an embodiment of the disclosure.

Referring to FIG. 8B, the unit-cell 620 according to an embodiment may be a cell including the dielectric body 621, the conductor unit 622, and/or the perforated unit 623.

FIG. 8C illustrates another unit-cell according to an embodiment of the disclosure.

Referring to FIG. 8C, a unit-cell 830 according to another embodiment may be a cell including a dielectric body outside 831, a dielectric body inside 832, a connecting unit 833, a first perforated unit 834, a second perforated unit 835, and/or a conductor unit 836.

When the upper surface of the unit-cell 830 and/or the lower surface thereof is separated into an outside part and an inside part by the first perforated unit 834 and/or the second perforated unit 835, the dielectric body outside 831 may correspond to the outside part. For example, the dielectric body outside 831 may correspond to the edge of the upper surface of the unit-cell 830 and/or the lower surface thereof.

When the upper surface of the unit-cell 830 and/or the lower surface thereof is separated into an outside part and an inside part by the first perforated unit 834 and/or the second perforated unit 835, the dielectric body inside 832 may correspond to the inside part.

The connecting unit 833 may be a member connecting the dielectric body outside 831 and the dielectric body inside 832.

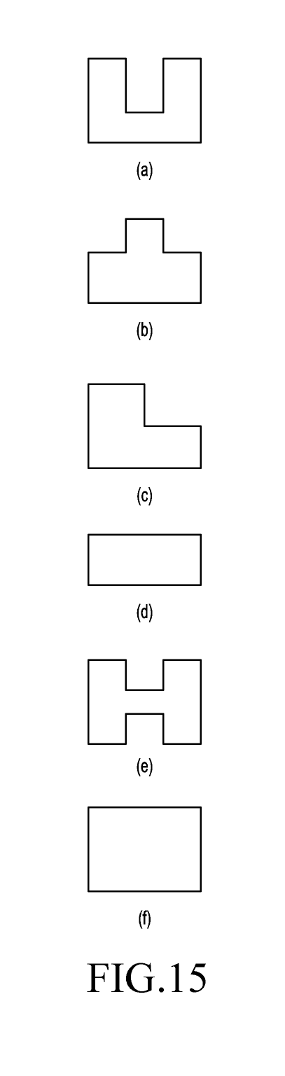

The first perforated unit 834 and/or the second perforated unit 835 may be a hole formed between the dielectric body outside and the dielectric body inside. For example, the first perforated unit 834 and the second perforated unit 835 may be formed in positions symmetrical with each other with reference to the center of the unit-cell 830, and may be formed in the same shape. For example, the first perforated unit 834 and/or the second perforated unit 835 may include at least one hole having various geometric shapes, such as “ [symbol] ” (a “U” shape), “ [symbol] ” (a modified square shape), “ [symbol] ” (an “L” shape), “ [symbol] ” (a rectangle shape), “ [symbol] ” (an “H” shape), or “ [symbol] ” (a square shape), as shown in FIG. 15 views (a), (b), (c), (d), (e) and (f), respectively.

The conductor unit 836 may be formed at the center part of the upper surface of the unit-cell 830 and/or the lower surface thereof. For example, when viewed from above the unit-cell 830, the conductor unit 836 may be shaped to be surrounded by the dielectric body inside 832.

FIG. 8D illustrates another unit-cell according to an embodiment of the disclosure.

Referring to FIG. 8D, a unit-cell 840 according to another embodiment may be a cell including a dielectric body outside 841, a dielectric body inside 842, a connecting unit 843, first to fourth perforated units 844-847, and/or a conductor unit 848.

When the upper surface of the unit-cell 840 and/or the lower surface thereof is separated into an outside part and an inside part by the first to fourth perforated units 844-847, the dielectric body outside 841 may correspond to the outside part. For example, the dielectric body outside 841 may correspond to the edge of the upper surface of the unit-cell 840 and/or the lower surface thereof.

When the upper surface of the unit-cell 840 and/or the lower surface thereof is separated into an outside part and an inside part by the first to fourth perforated units 844-847, the dielectric body inside 842 may correspond to the inside part.

The connecting unit 843 may be a member connecting the dielectric body outside 841 and the dielectric body inside 842.

The first to fourth perforated units 844-847 may be holes formed between the dielectric body outside and the dielectric body inside. For example, the first to fourth perforated units 844-847 may be formed in positions symmetrical with each other with reference to the center of the unit-cell 840, and may be formed in the same shape. In addition, when the unit-cell 840 is viewed from above, the first to fourth perforated units 844-847 may be formed on respective corners of the upper surface. For example, the first to fourth perforated units 844-847 may include at least one hole having the geometric shape of “ [symbol] ” as shown in FIG. 15 (c).

The conductor unit 848 may be formed at the center part of the upper surface of the unit-cell 840 and/or the lower surface thereof. For example, when the unit-cell 840 is viewed from above, the conductor unit 848 may be shaped to be surrounded by the dielectric body inside 842.

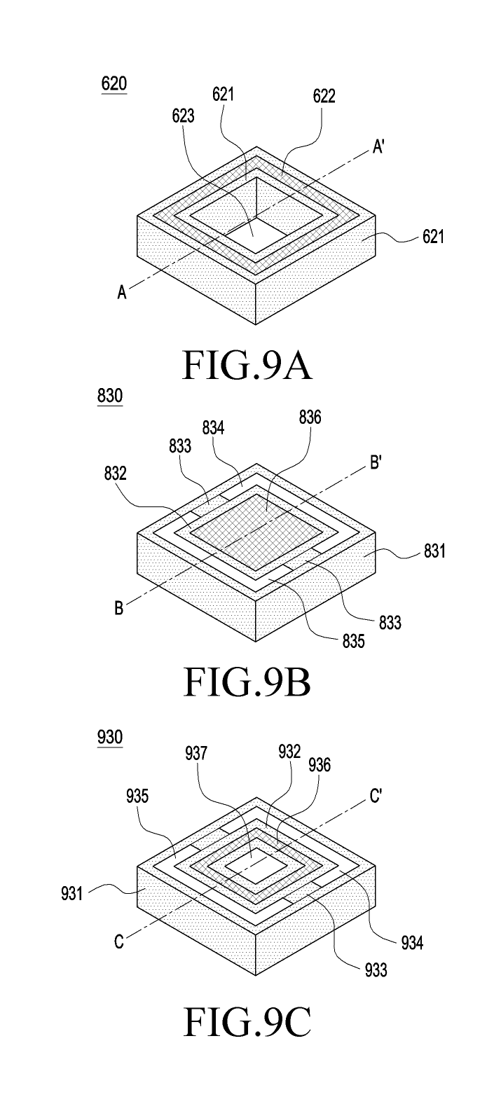

FIGS. 9A to 9C are perspective views of antenna unit-cells according to embodiments of the disclosure.

FIG. 9A is a perspective view of the unit-cell 620 of FIG. 6B and FIG. 8B according to an embodiment of the disclosure.

Referring to FIG. 9A, the unit-cell 620 according to an embodiment may be a cell including the dielectric body 621, the conductor unit 622, and/or the perforated unit 623.

FIG. 9B is a perspective view of the unit-cell 830 of FIG. 8C according to an embodiment of the disclosure.

Referring to FIG. 9B, the unit-cell 830 according to another embodiment may be a cell including the dielectric body outside 831, the dielectric body inside 832, the connecting unit 833, the first perforated unit 834, the second perforated unit 835, and/or the conductor unit 836.

FIG. 9C is a perspective view of a unit-cell 930 according to an embodiment of the disclosure.

Referring to FIG. 9C, the unit-cell 930 may be a cell including a dielectric body outside 931, a dielectric body inside 932, a connecting unit 933, a first perforated unit 934, a second perforated unit 935, a conductor unit 936, and/or a third perforated unit 937. For example, the unit-cell 930 may include the first perforated unit 934 and the second perforated unit 935 that penetrate the upper surface of the unit-cell 930 and the lower surface thereof between the dielectric body outside 931 and the dielectric body inside 932. For example, the first perforated unit 934 and the second perforated unit 935 may be formed in positions symmetrical with each other with reference to the center of the unit-cell 930, and may be formed in the same shape. The connecting unit 933 may be a member connecting the dielectric body outside 931 and the dielectric body inside 932.

The unit-cell 930 may further include the third perforated unit 937 provided in the dielectric body inside 932 so as to penetrate the upper surface of the unit-cell 930 and the lower surface thereof.

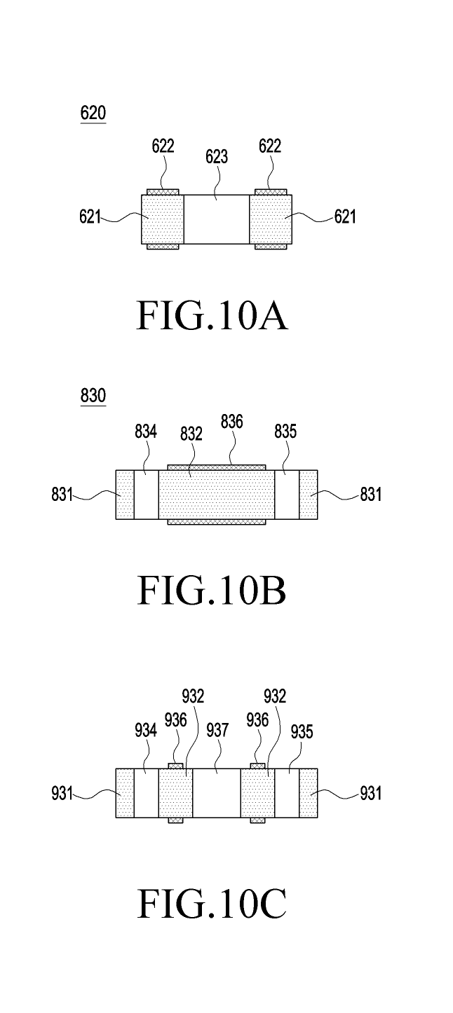

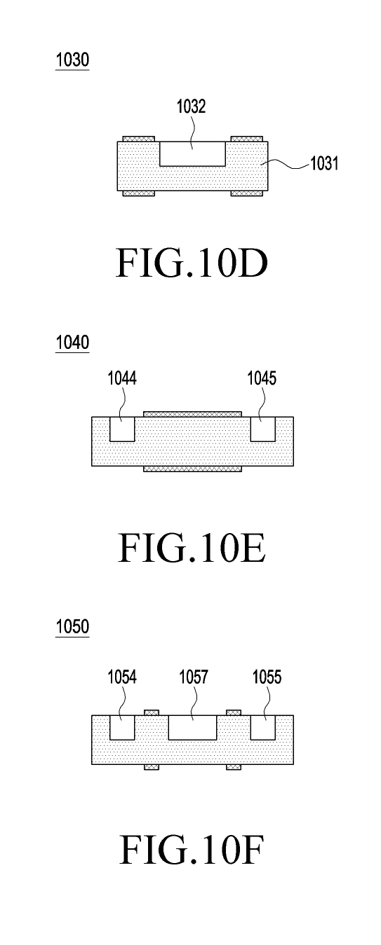

FIG. 10A is a sectional view of an antenna unit-cell according to various embodiments of the disclosure. FIG. 10B is a sectional view of an antenna unit-cell according to various embodiments of the disclosure. FIG. 10C is a sectional view of an antenna unit-cell according to various embodiments of the disclosure. FIG. 10D is a sectional view of an antenna unit-cell according to various embodiments of the disclosure. FIG. 10E is a sectional view of an antenna unit-cell according to various embodiments of the disclosure. FIG. 10F is a sectional view of an antenna unit-cell according to various embodiments of the disclosure.

FIG. 10A is a sectional view of the unit-cell 620 of FIG. 9A taken along dotted line A-A′ according to an embodiment of the disclosure.

Referring to FIG. 10A, the perforated unit 623 penetrates the upper surface of the unit-cell 620 and the lower surface thereof.

FIG. 10B is a sectional view of the unit-cell 830 of FIG. 9B taken along dotted line B-B′ according to an embodiment of the disclosure.

Referring to FIG. 10B, the first perforated unit 834 and the second perforated unit 835 penetrate the upper surface of the unit-cell 830 and the lower surface thereof.

FIG. 10C is a sectional view of the unit-cell 930 of FIG. 9C taken along dotted line C-C′ according to an embodiment of the disclosure.

Referring to FIG. 10C, the first perforated unit 934, the second perforated unit 935, and the third perforated unit 937 penetrate the upper surface of the unit-cell 930 and the lower surface thereof.

FIG. 10D illustrates, as an example of an application of the unit-cell 620 illustrated in FIG. 10A, a sectional view of another antenna unit-cell according to an embodiment of the disclosure.

Referring to FIG. 10D, a case is shown where a unit-cell 1030 has a perforated unit 1031 including a groove 1032. The groove may also be referred to as a recess. Although the perforated unit 1031 penetrates the upper surface of the unit-cell 1030 and the lower surface thereof, the groove 1032 may denote a cutout corresponding to a part of the height of the unit-cell 1030.

FIG. 10E illustrates, as an example of application of the unit-cell 830 illustrated in FIG. 10B, a sectional view of another antenna unit-cell according to an embodiment of the disclosure.

Referring to FIG. 10E, a case is shown where the first perforated unit 834 and the second perforated unit 835 of a unit-cell 1040 are replaced with a first groove 1044 and a second groove 1045. Although the replaced first perforated unit and the second perforated unit penetrate the upper surface of the unit-cell and the lower surface thereof, the first groove 1044 and the second groove 1045 may denote cutouts corresponding to a part of the height of the unit-cell 1040.

FIG. 10F illustrates, as an example of application of the unit-cell 930 illustrated in FIG. 10C, a sectional view of another antenna unit-cell according to an embodiment of the disclosure.

Referring to FIG. 10F, a case is shown where the first perforated unit 934, the second perforated unit 935, and the third perforated unit 937 of a unit-cell 1050 are replaced with a first groove 1054, a second groove 1055, and a third groove 1057. Although the replaced first perforated unit, second perforated unit, and third perforated unit penetrate the upper surface of the unit-cell and the lower surface thereof, the first groove 1054, the second groove 1055, and the third groove 1057 may denote cutouts corresponding to a part of the height of the unit-cell 1050.

That is, FIG. 10A to FIG. 10F illustrate cases where holes may be formed in unit-cells at various depths.

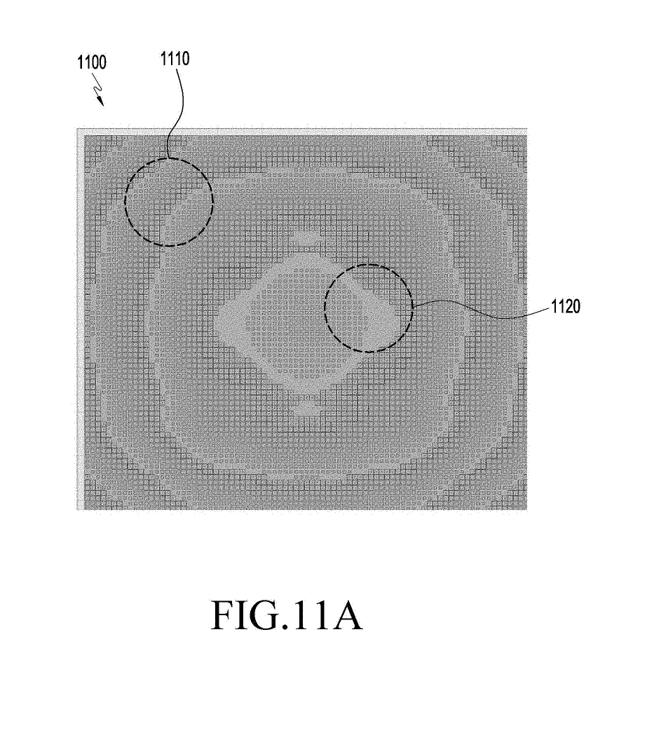

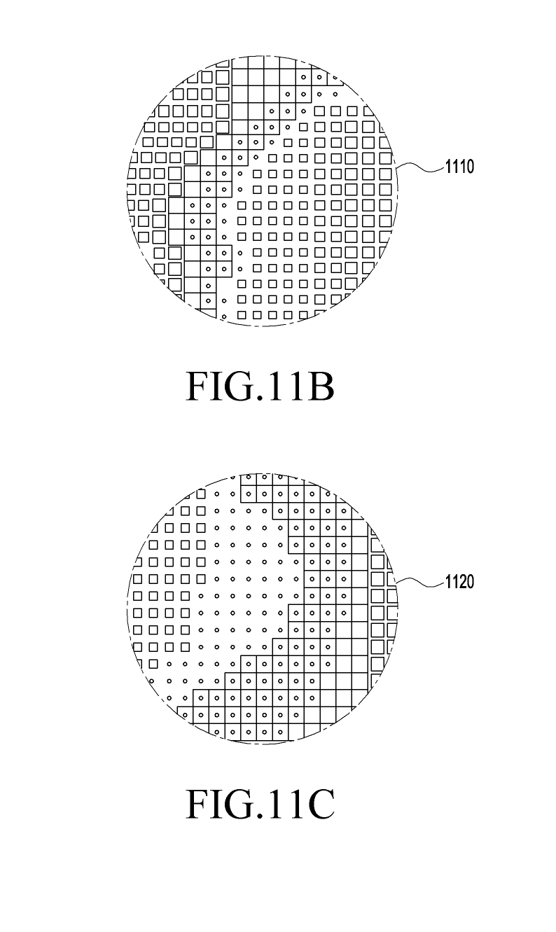

FIG. 11A illustrates a type of arrangement of at least one unit-cell on a lens antenna according to an embodiment of the disclosure. FIG. 11B illustrates an exemplary type of arrangement of at least one unit-cell on a lens antenna according to one of various embodiments of the disclosure. FIG. 11C illustrates an exemplary type of arrangement of at least one unit-cell on a lens antenna according to one of various embodiments of the disclosure.

Referring to FIG. 11A, a lens antenna 1100 includes at least one unit-cell. For example, the at least one unit-cell and the substrate of the lens antenna 1100 may be coupled to each other by chemical and/or physical coupling.

For example, the at least one unit-cell may be arranged in the shape of a closed loop that is symmetrical with reference to the same center point as illustrated in FIG. 11A. The closed loop may have the shape of a circle (or a ring) as illustrated in FIG. 11A, or another shape such as a trapezoid, a quadrangle, or a pentagon. Parts 1110 and 1120 are shown and described in greater detail below.

For example, the at least one unit-cell included in the lens antenna 1100 may be configured as a dielectric body having the same permittivity, but the size (or shape or number) of the perforated unit may vary, or the size (or shape or number) of the conductor unit may vary.

As another example, the lens antenna 1100 may include at least one unit-cell, where at least one of the permittivity, the size (or shape or number) of the perforated unit, or the size (or shape or number) of the conductor unit of the unit-cell is different.

FIG. 11B is a magnified view of part 1110 in FIG. 11A. FIG. 11C is a magnified view of part 1120 in FIG. 11A.

Referring to FIG. 11B and FIG. 11C, each dot corresponds to one of the perforated units according to embodiments of the disclosure, and each quadrangle may correspond to the conductor units according to embodiments of the disclosure. For example, a quadrangle including a dot may be a unit-cell including all of a dielectric body, a conductor unit, and a perforated unit.

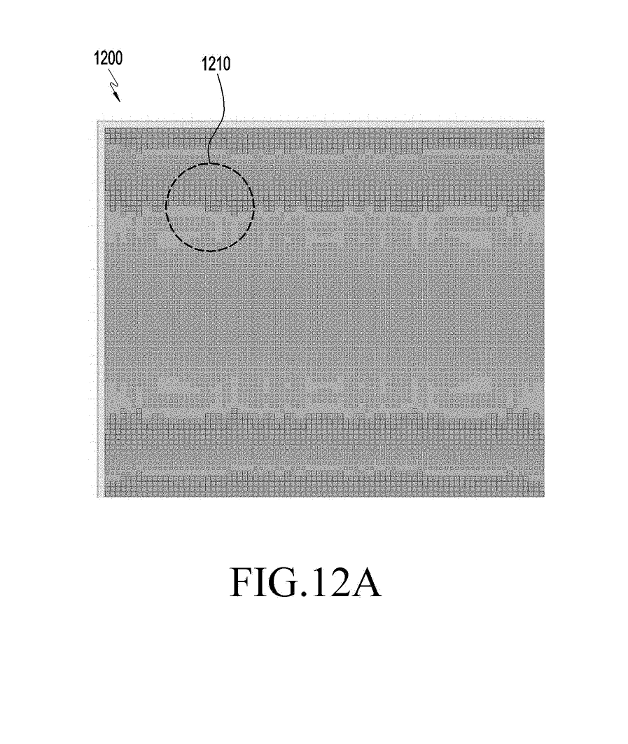

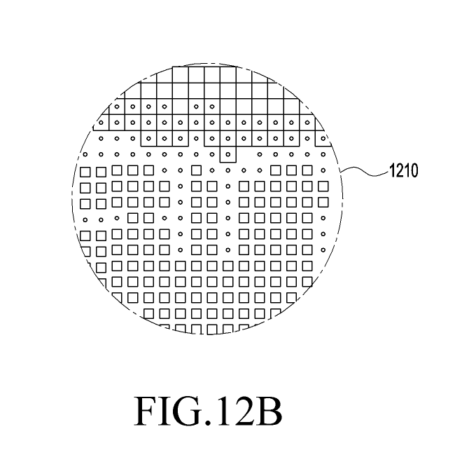

FIG. 12A illustrates another type of arrangement of at least one unit-cell on a lens antenna according to an embodiment of the disclosure. FIG. 12B illustrates an enlargement of a type of arrangement of at least one unit-cell on a lens antenna according to an embodiment of the disclosure.

Referring to FIG. 12A, a lens antenna 1200 includes at least one unit-cell. Part 1210 is shown and described in greater detail below.

For example, the at least one unit-cell may be arranged in the shape of an open loop as illustrated in FIG. 12A and FIG. 12B.

For example, the at least one unit-cell included in the lens antenna 1200 may be configured as a dielectric body having the same permittivity, but the size (or shape or number) of the perforated unit may vary, or the size (or shape or number) of the conductor unit may vary.

As another example, the lens antenna 1200 may include at least one unit-cell, where at least one of the permittivity, the size (or shape or number) of the perforated unit, or the size (or shape or number) of the conductor unit of the unit-cell is different.

FIG. 12B is a magnified view of the part 1210 in FIG. 12A.

Referring to FIG. 12B, each dot corresponds to one of perforated units according to embodiments of the disclosure, and each quadrangle may correspond to a conductor unit according to embodiments of the disclosure. For example, a quadrangle including a dot may be a unit-cell including all of a dielectric body, a conductor unit, and a perforated unit.

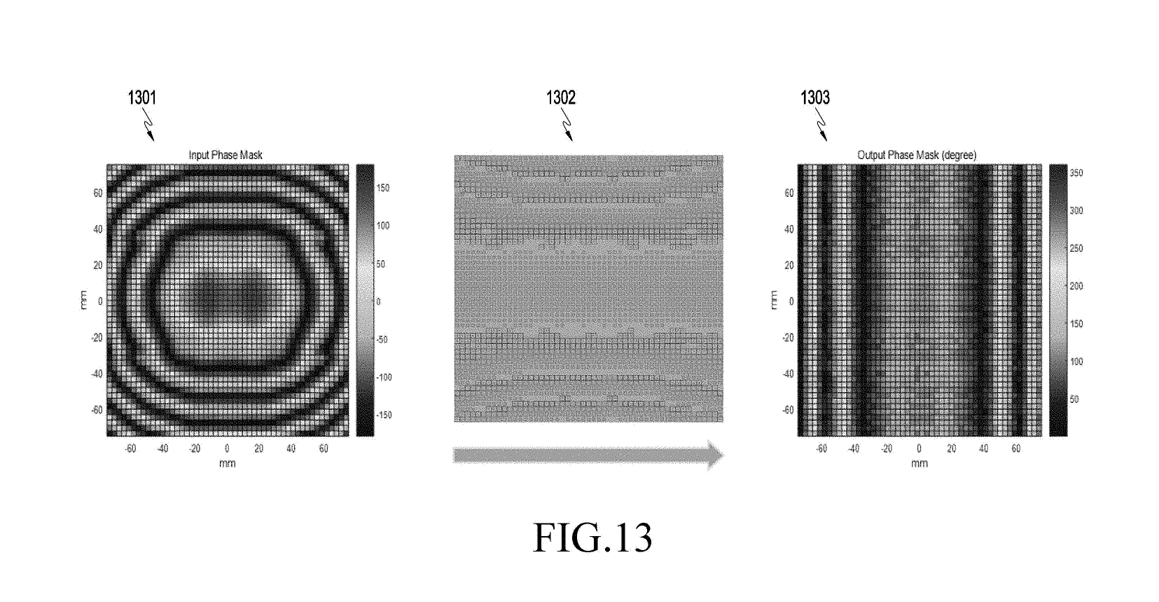

FIG. 13 illustrates a result of a signal passing through a lens antenna according to an embodiment of the disclosure.

Referring to FIG. 13, an output signal 1303 is shown resulting from an input signal 1301 that has penetrated (passed through) a lens antenna 1302. The output signal 1303 is merely a result of experiments, and may differ in other cases.

The lens antenna 1302 may include at least one unit-cell arranged in the shape of an open loop as illustrated in FIG. 13, and the at least one unit-cell may also be arranged in a different shape (for example, a closed loop).

The input signal 1301 may denote an ideal input value, for example, and the output signal 1303 may denote an ideal result value.

In FIG. 13, the output signal 1303 (for example, an ideal output signal) illustrates a result wherein the phase (ϕ) is identical when the distance (for example, x-axis distance) from the center of the lens antenna is identical.

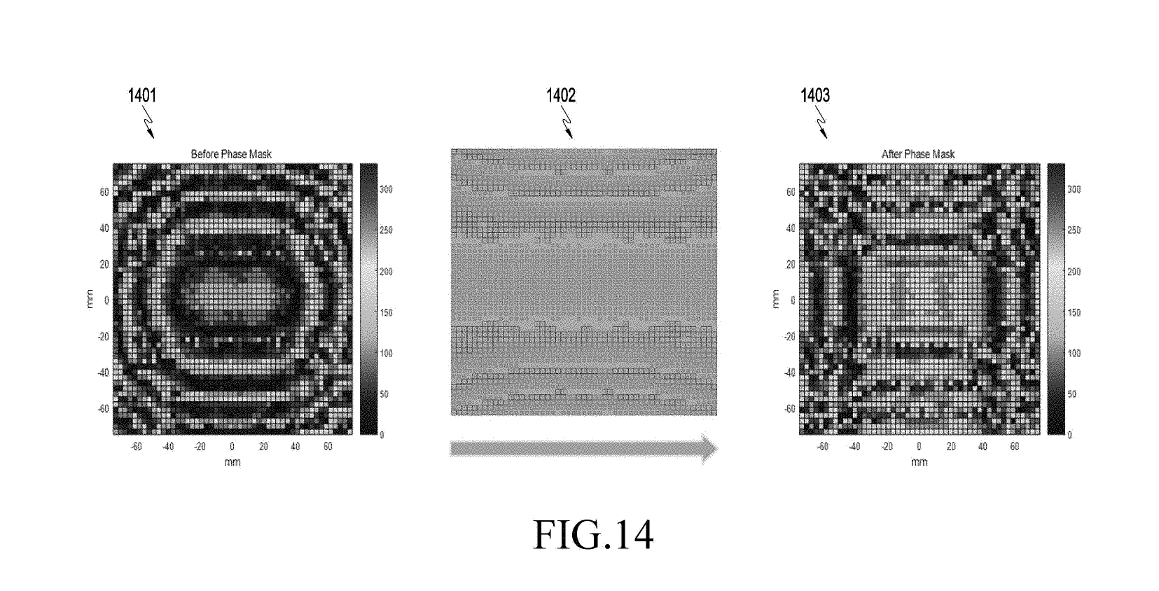

FIG. 14 illustrates a result of another signal passing through a lens antenna according to an embodiment of the disclosure.

Referring to FIG. 14, an output signal 1403 is shown resulting from an input signal 1401 that has penetrated (passed through) a lens antenna 1402. The output signal 1403 is merely a result of experiments, and may differ in other cases.

The lens antenna 1402 may include at least one unit-cell arranged in the shape of an open loop as illustrated in FIG. 14, and the at least one unit-cell may also be arranged in a different shape (for example, a closed loop).

The input signal 1401 may denote an input value similar to that in an actual communication environment, for example, and the output signal 1403 may denote a result value in an actual communication environment.

It would be obvious to a person skilled in the art to which the disclosure pertains that the above-described electronic devices and electronic device antenna structures according to various embodiments are not limited to the above-mentioned embodiments and drawings, and various substitutions, modifications, and changes are possible within the technical scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An antenna device comprising:
at least one unit-cell, wherein the at least one unit-cell comprises:
a dielectric body comprising a member having a degree of permittivity; and
a perforated unit configured to penetrate an upper surface and a lower surface of the dielectric body.

2. The antenna device of claim 1, further comprising a conductor unit positioned on at least one of the upper surface or the lower surface of the dielectric body.

3. The antenna device of claim 2, wherein the conductor unit comprises at least one metal or metal alloy material.

4. The antenna device of claim 1, wherein a center point of the dielectric body and a center point of the perforated unit are substantially identical.

5. The antenna device of claim 1, wherein the perforated unit is positioned between an outside of the dielectric body and an inside of the dielectric body.

6. The antenna device of claim 5, further comprising a connecting unit configured to connect the outside of the dielectric body and the inside of the dielectric body.

7. The antenna device of claim 5, further comprising an inside perforated unit configured to penetrate an upper surface of the inside of the dielectric body and a lower surface of the inside of the dielectric body.

8. The antenna device of claim 1, wherein the perforated unit comprises at least one hole having a “U” shape or an “L” shape.

9. The antenna device of claim 1, further comprising a lens antenna.

10. The antenna device of claim 9, wherein the at least one unit-cell is arranged on one side of the lens antenna as a closed loop that is symmetrical with reference to a center point of the lens antenna.

11. The antenna device of claim 9,
wherein the antenna device further comprises an array antenna, and
wherein an output of the array antenna is input to the lens antenna comprising the at least one unit-cell.

12. An antenna device comprising:
at least one unit-cell, wherein the at least one unit-cell comprises:
a dielectric body comprising a member having a degree of permittivity; and
a conductor unit arranged on at least one of an upper surface of the dielectric body or a lower surface of the dielectric body.

13. The antenna device of claim 12, further comprising a perforated unit configured to penetrate the upper surface of the dielectric body and the lower surface of the dielectric body.

14. The antenna device of claim 13,
wherein the perforated unit is positioned between the outside of the dielectric body and the inside of the dielectric body, and
wherein the at least one unit-cell further comprises a connecting unit configured to connect the outside of the dielectric body and inside of the dielectric body.

15. The antenna device of claim 14, further comprising an inside perforated unit configured to penetrate an upper surface of the inside of the dielectric body and a lower surface of the inside of the dielectric body.

16. The antenna device of claim 13, wherein the perforated unit comprises at least one hole having a “U” shape or an “L” shape.

17. A unit-cell provided on a lens antenna, the unit-cell comprising:
a dielectric body comprising a member having a degree of permittivity; and
a perforated unit configured to penetrate an upper surface of the dielectric body and a lower surface of the dielectric body.

18. The unit-cell of claim 17, further comprising a conductor unit positioned on at least one of the upper surface of the dielectric body or the lower surface of the dielectric body.

19. A unit-cell provided on a lens antenna, the unit-cell comprising:
a dielectric body comprising a member having a degree of permittivity; and
a conductor unit positioned on at least one of an upper surface of the dielectric body or a lower surface of the dielectric body.

20. The unit-cell of claim 19, further comprising a perforated unit configured to penetrate the upper surface of the dielectric body and the lower surface of the dielectric body.
